(19) United States
(12) Patent Application Publication
(10) Pub. No.: US 2019/0392656 A1
(43) Pub. Date: Dec. 26, 2019

(54) METHOD AND APPARATUS FOR LEAK DETECTION

(71) Applicant: GM GLOBAL TECHNOLOGY OPERATIONS LLC, DETROIT, MI (US)

(72) Inventors: Azeem Sarwar, Rochester Hills (US); Pulasti Bandara, Novi, MI (US); Mark R. Claywell, Birmingham, MI (US); Maqsood Rizwan Ali Khan, Rochester Hills, MI (US)

(21) Appl. No.: 16/016,092

(22) Filed: Jun. 22, 2018

(51) Int. Cl. G07C 5/08; G08B 21/20; G08B 21/18; G06T 7/00; B60R 11/04

(52) U.S. Cl. CPC G07C 5/0816; G08B 21/20; G08B 21/182; G06T 7/62; B60R 11/04; G06T 2207/10024; G06T 2207/30264; G06T 7/97

(57) ABSTRACT

A method and apparatus that detect a leak of vehicle fluid are provided. The method includes determining whether leak detection is active, capturing a first image of an area while parking a vehicle into the area if the leak detection is active, capturing a second image of the area while the vehicle is exiting from the area, comparing the first image and the second image to detect whether the leak is present, and outputting a notification indicating a leak is present if the comparing detects the leak.

### INTRODUCTION

Apparatuses and methods consistent with exemplary embodiments relate to leak detection. More particularly, apparatuses and methods consistent with exemplary embodiments relate to detecting fluid leaks from vehicles.

### SUMMARY

One or more exemplary embodiments provide a method and an apparatus that detect a leak of vehicle fluid by analyzing images of a camera. More particularly, one or more exemplary embodiments provide a method and an apparatus that detect a leak of vehicle fluid and that determine the potential source of the leak.

According to an aspect of an exemplary embodiment, a method for detecting a leak of a vehicle fluid is provided. The method includes determining whether leak detection is active, capturing a first image of an area while parking a vehicle into the area if the leak detection is active, capturing a second image of the area while the vehicle is exiting from the area, comparing the first image and the second image to detect whether the leak is present, and outputting a notification indicating a leak is present if the comparing detects the leak.

The method may also include determining whether the detected leak is a recurring leak based on historical leak information, and incrementing a leak detection counter if the detected leak is determined to be a recurring leak. The outputting the notification may include outputting the notification if the leak detection counter is above a predetermined threshold number.

The determining whether leak detection is active may include determining whether rain, snow or other environmental moisture is possible based on at least one from among a rain sensor, weather information, and images provided a camera, determining whether a speed of the vehicle is less than a predetermined threshold speed, and activating the leak detection if the environmental moisture is not possible and the vehicle speed is less than the predetermined threshold speed.

The capturing the second image of the area upon exiting the vehicle from the area may include capturing an image after the vehicle shifts from a stationary vehicle setting to a setting that corresponds to vehicle motion and the vehicle begins moving from the area.

The method may also include detecting a direction of entry into the area where the vehicle will be parked, the capturing the first image may include capturing the first image of the area with a camera facing the area in front of the vehicle if the direction of entry is a forward direction into the area, and the capturing the first image may include capturing the first image of the area with a camera facing the area behind the vehicle if the direction of entry is a reverse entry into the area.

The method may include detecting a direction of exit from the area where the vehicle was parked, the capturing the second image may include capturing the second image of the area with a camera facing the area in front of the vehicle if the direction of exit is a reverse exit from the area, and the capturing the second image may include capturing the second image of the area with a camera facing the area behind the vehicle if the direction of exit is a forward exit from the area.

The comparing the first image and the second image to detect whether the leak is present may include comparing colors of pixels of the first image to colors of pixels of the second image.

The comparing the first image and the second image to detect whether the leak is present may further include determining a location of the leak based on the comparing of the colors, determining if the location of the leak corresponds to a location on the vehicle where a leak may occur, determining a size of the leak, and determining a type of the leak based on one or more from among the size of the leak, the location of the leak, and the color of the pixels.

The comparing the first image and the second image to detect whether the leak is present may further include cross-referencing the determined leak type with information from one or more from among other sensors, vehicle systems, vision systems or a vehicle operator and updating the determined leak type based on the cross-referencing.

According to an aspect of another exemplary embodiment, an apparatus that detects a leak of a vehicle fluid is provided. The apparatus includes at least one memory comprising computer executable instructions; and at least one processor configured to read and execute the computer executable instructions. The computer executable instructions cause the at least one processor to determine whether leak detection is active, capture a first image of an area while parking a vehicle into the area if the leak detection is active, capture a second image of the area while the vehicle is exiting from the area, compare the first image and the second image to detect whether the leak is present, and control to output a notification indicating a leak is present if the comparing detects the leak.

The computer executable instructions may further cause the at least one processor to determine whether the detected leak is a recurring leak based on historical leak information, increment a leak detection counter if the detected leak is determined to be a recurring leak, and output the notification by outputting the notification if the leak detection counter is above a predetermined threshold number.

The computer executable instructions further cause the at least one processor to determine whether leak detection is active by determining whether rain, snow or other environmental moisture is possible based on at least one from among a rain sensor, weather information, and images provided a camera, determining whether a speed of the vehicle is less than a predetermined threshold speed, and activating the leak detection if the environmental moisture is not possible and the speed of the vehicle is less than the predetermined threshold speed.

The computer executable instructions may further cause the at least one processor to capture the second image of the area upon exiting the vehicle from the area by capturing an image after the vehicle shifts from a stationary vehicle setting to a setting that corresponds to vehicle motion and the vehicle begins moving from the area.

The computer executable instructions may further cause the at least one processor to detect a direction of entry into the area where the vehicle will be parked, capture the first image by capturing the first image of the area with a camera facing the area in front of the vehicle if the direction of entry is a forward direction into the area, and capture the first image by capturing the first image of the area with a camera facing the area behind the vehicle if the direction of entry is a reverse entry into the area.

The computer executable instructions may further cause the at least one processor to detect a direction of exit from the area where the vehicle was parked, capture the second image by capturing the second image of the area with a camera facing the area in front of the vehicle if the direction of exit is a reverse exit from the area, and capture the second image by capturing the second image of the area with a camera facing the area behind the vehicle if the direction of exit is a forward exit from the area.

The computer executable instructions may further cause the at least one processor to compare the first image and the second image to detect whether the leak is present by comparing colors of pixels of the first image to colors of pixels of the second image.

The computer executable instructions may further cause the at least one processor to compare the first image and the second image to detect whether the leak is present by determining a location of the leak based on the comparing of the colors, determining if the location of the leak corresponds to a location on the vehicle where a leak may occur, determining a size of the leak, and determining a type of the leak based on one or more from among the size of the leak, the location of the leak, and the color of the pixels.

The computer executable instructions may further cause the at least one processor to compare the first image and the second image to detect whether the leak is present by cross-referencing the determined leak type with information from one or more from among other sensors, vehicle systems, vehicle maintenance history, vision systems or a vehicle operator and updating the determined leak type based on the cross-referencing.

The computer executable instructions may further cause the at least one processor to assign a confidence score to the determined type of leak based on the information from one or more from among other sensors, vehicle systems, vision systems or a vehicle operator and updating the determined leak type based on the cross-referencing.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that detects a leak of a vehicle fluid according to an exemplary embodiment;

FIG. 2 shows a flowchart for a method for detecting a leak of a vehicle fluid according to an exemplary embodiment;

FIG. 3 shows a flowchart for a method for determining whether leak detection is active according to an aspect of an exemplary embodiment;

FIG. 4 shows a flowchart for a method for detecting whether a leak is present according to an aspect of an exemplary embodiment; and

FIGS. 5A-5C show illustrations of the leak detection process according to an aspect of an exemplary embodiment.

### DETAILED DESCRIPTION

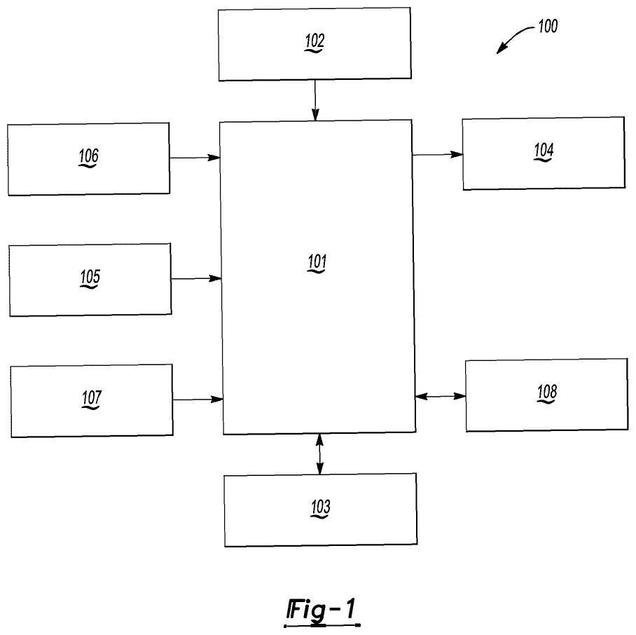

An apparatus and method that detect a leak of a vehicle fluid will now be described in detail with reference to FIGS. 1-5C of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or combined into one or more devices. In addition, individual elements may be provided on separate devices.

Vehicles such as a passenger car, trucks, sports utility vehicles (SUVs), recreational vehicles (RVs), marine vessels, aircraft, etc., are being equipped with imaging and/or vision systems. For example, vehicles may have cameras or other imaging sensors facing one or more areas around a vehicle such as a front facing camera, a rear facing camera, a side facing camera. These cameras and imaging sensors may be used to perceive or capture images of an environment around a vehicle. The images may be analyzed to determine the presence of objects and/or other indicators or interest.

One type of issue that may occur with a vehicle is a fluid leak. The fluid leak may be sometimes go undetected due to the small volume of fluid lost or due to the fact it is occurs in locations generally covered by the vehicle. Moreover, sensors to detect leaks add cost to the vehicle. However, image sensors already in use in a vehicle may be used to perceive or capture images of areas where a leak may occur. These images can then be analyzed and cross referenced with other information to determine the presence of the leak, the type of leak, and a confidence factor in detection of the leak.

FIG. 1 shows a block diagram of an apparatus detects a leak of a vehicle fluid 100 according to an exemplary embodiment. As shown in FIG. 1, the apparatus detects a leak of a vehicle fluid 100, according to an exemplary embodiment, includes a controller 101, a power supply 102, a storage 103, an output 104, an environmental moisture detector 105, a user input 106, an imaging sensor 107, and a communication device 108. However, the apparatus detects a leak of a vehicle fluid 100 is not limited to the aforementioned configuration and may be configured to include additional elements and/or omit one or more of the aforementioned elements. The apparatus detects a leak of a vehicle fluid 100 may be implemented as part of a vehicle or as a standalone component.

The controller 101 controls the overall operation and function of the apparatus detects a leak of a vehicle fluid 100. The controller 101 may control one or more of a storage 103, an output 104, an environmental moisture detector 105, a user input 106, an imaging sensor 107, and a communication device 108 of the apparatus detects a leak of a vehicle fluid 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the environmental moisture detector 105, the user input 106, the imaging sensor 107, and the communication device 108 of the apparatus detects a leak of a vehicle fluid 100. The information may be sent and received via a bus or network, or may be directly read or written to/from one or more of the storage 103, the output 104, the user input 106, the imaging sensor 107, and the communication device 108 of the apparatus detects a leak of a vehicle fluid 100. Examples of suitable network connections include a controller area network (CAN), a media oriented system transfer (MOST), a local interconnection network (LIN), a local area network (LAN), and other appropriate connections such as Ethernet.

The power supply 102 provides power to one or more of the controller 101, the storage 103, the output 104, the user input 106, the imaging sensor 107, and the communication device 108 of the apparatus detects a leak of a vehicle fluid 100. The power supply 102 may include one or more from among a battery, an outlet, a capacitor, a solar energy cell, a generator, a wind energy device, an alternator, etc.

The storage 103 is configured for storing information and retrieving information used by the apparatus detects a leak of a vehicle fluid 100. The storage 103 may be controlled by the controller 101 to store and retrieve image information of the imaging sensor 107 such as a first image and a second image, information corresponding to a leak detection counter, historical leak information, information provided by the environmental moisture sensor 105, information on a confidence score, information from various vehicle systems, vehicle sensors, and external systems and sensors. The storage 103 may also include the computer instructions configured to be executed by a processor to perform the functions of the apparatus detects a leak of a vehicle fluid 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus detects a leak of a vehicle fluid 100. The output 104 may include one or more from among a speaker, a display, a transparent display, a centrally-located display, a head up display, a windshield display, a haptic feedback device, a vibration device, a tactile feedback device, a tap-feedback device, a holographic display, an instrument light, an indicator light, etc. In addition, the output 104 may also include a transparent display located on one or more of a windshield, a rear window, side windows, and mirrors of a vehicle.

The output 104 may output a notification including one or more from among an audible notification, a light notification, and a display notification. The notification may include information regarding one or more from among the type leaked fluid, the location of the leaked fluid, the confidence score corresponding to detection of the leaked fluid, fluid quality of the leaked fluid.

The user input 106 is configured to provide information and commands to the apparatus detects a leak of a vehicle fluid 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. Moreover, the user input 106 may be a receive an operator input to confirm the presence of a detected leak and/or confirm the type of the detected leak. The user input 106 may also be configured to receive a user input to cycle through notifications or different screens of a notification.

The imaging sensor 107 may be one or more from among a camera, an infrared sensor or other imaging device. The imaging sensor 107 may face an area in front of a vehicle and may also face an area behind a vehicle.

The communication device 108 may be used by the apparatus detects a leak of a vehicle fluid 100 to communicate with several types of external apparatuses according to various communication methods. The communication device 108 may be used to send/receive notifications of a detected leak and information such as images taken from external cameras to/from the controller 101 of the apparatus detects a leak of a vehicle fluid 100. The notification or warning may be sent by the communication device 108 to an output device or display, such as output 104, a mobile device, or other external device.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long term evolution (LTE), Bluetooth, EVDO, CDMA, GPRS, EDGE or ZigBee.

The controller 101 of the apparatus detects a leak of a vehicle fluid 100 may be configured to determine whether leak detection is active, capture a first image of an area while parking a vehicle into the area if the leak detection is active, capture a second image of the area while the vehicle is exiting from the area, compare the first image and the second image to detect whether the leak is present, and output a notification indicating a leak is present if the comparing detects the leak.

The controller 101 of the apparatus detects a leak of a vehicle fluid 100 may also be configured to determine whether the detected leak is a recurring leak based on historical leak information, increment a leak detection counter if the detected leak is determined to be a recurring leak, and output the notification by outputting the notification if the leak detection counter is above a predetermined threshold number.

The controller 101 of the apparatus detects a leak of a vehicle fluid 100 may also be configured to determine whether leak detection is active by determining whether rain, snow or other environmental moisture is possible based on at least one from among a rain sensor, weather information, and images provided a camera, determining whether a speed of the vehicle is less than a predetermined threshold speed, and activating the leak detection if the environmental moisture is not possible and the speed of the vehicle is less than the predetermined threshold speed.

The controller 101 of the apparatus that detects a leak of a vehicle fluid 100 may also be configured to capture the second image of the area upon exiting the vehicle from the area by capturing an image after the vehicle shifts from a stationary vehicle setting to a setting that corresponds to vehicle motion and the vehicle begins moving from the area.

The controller 101 of the apparatus that detects a leak of a vehicle fluid 100 may also be configured to detect a direction of entry into the area where the vehicle will be parked, capture the first image by capturing the first image of the area with a camera facing the area in front of the vehicle if the direction of entry is a forward direction into the area, and capture the first image by capturing the first image of the area with a camera facing the area behind the vehicle if the direction of entry is a reverse entry into the area.

The controller 101 of the apparatus that detects a leak of a vehicle fluid 100 may also be configured to detect a direction of exit from the area where the vehicle was parked, capture the second image by capturing the second image of the area with a camera facing the area in front of the vehicle if the direction of exit is a reverse exit from the area, and capture the second image by capturing the second image of the area with a camera facing the area behind the vehicle if the direction of exit is a forward exit from the area.

The controller 101 of the apparatus that detects a leak of a vehicle fluid 100 may also be configured to compare the first image and the second image to detect whether the leak is present by comparing colors of pixels of the first image to colors of pixels of the second image. The first and second image may each comprise a plurality of images. The controller 101 may compare the first image and the second image to detect whether the leak is present by determining a location of the leak based on the comparing of the colors, determining if the location of the leak corresponds to a location on the vehicle where a leak may occur, determining a size of the leak, determining a viscosity of the leaked fluid based on the transparency of the fluid and the color of the surface where the leak is detected, and determining a type of the leak based on one or more from among the size of the leak, the location of the leak, and the color of the pixels. The controller may further compare the first image and the second image to detect whether the leak is present by cross-referencing the determined leak type with information from one or more from among other sensors, vehicle systems, vehicle maintenance history, vision systems or a vehicle operator and updating the determined leak type based on the cross-referencing. The controller 101 may further assign a confidence score to the determined type of leak based on the information from one or more from among other sensors, vehicle systems, vision systems or a vehicle operator and updating the determined leak type based on the cross-referencing.

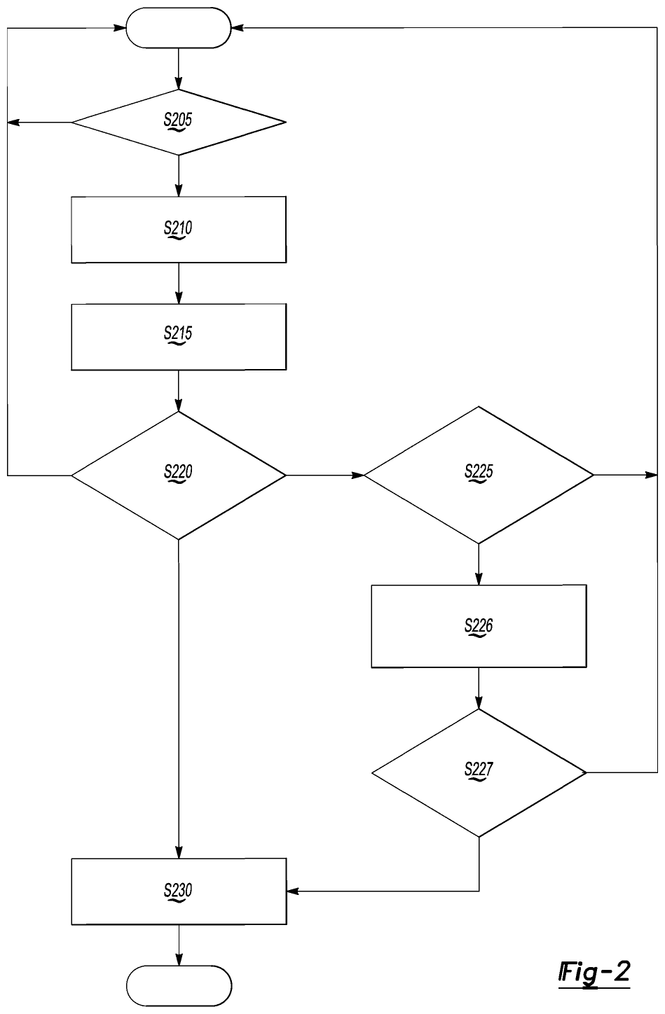

FIG. 2 shows a flowchart for a method for detecting a leak of a vehicle fluid according to an exemplary embodiment. The method of FIG. 2 may be performed by the apparatus detects a leak of a vehicle fluid 100 or may be encoded into a computer readable medium as instructions that are executable by a computer to perform the method.

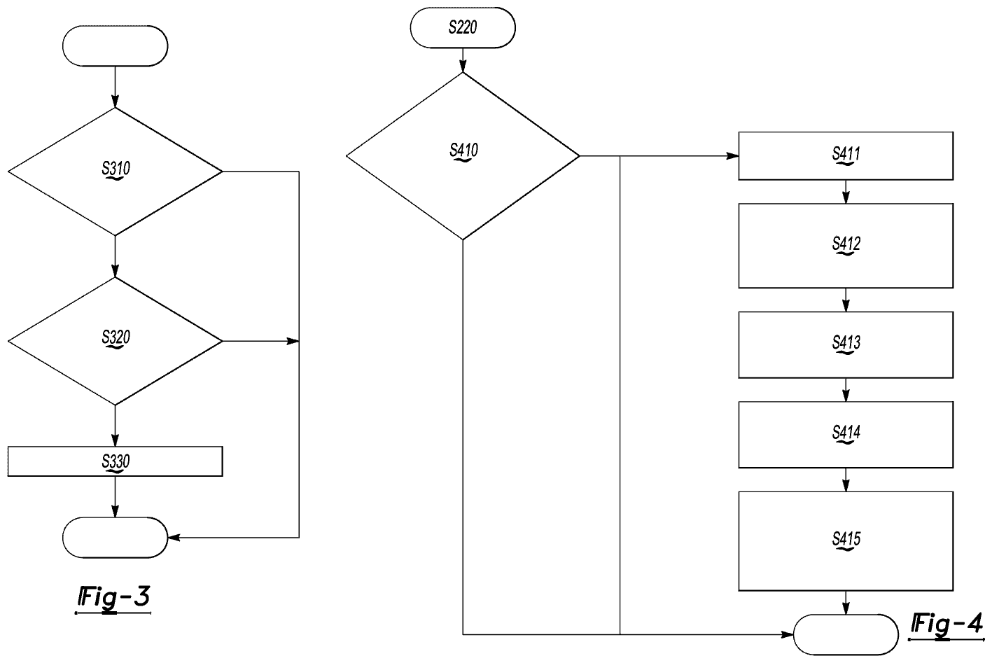

Referring to FIG. 2, it is determined whether leak detection is active in operation S205. The determination in operation S205 may be triggered by detecting location information corresponding to a parking spot, a vehicle control sequence corresponding to parking a vehicle, vehicle movement corresponding to parking a vehicle, the speed of the vehicle, or an input by an operator of a vehicle. The detailed process of determining whether leak detection is active is described below with reference to FIG. 3.

If leak detection is active (operation S205-Yes), a first image of a parking area is captured while parking the vehicle operation S210. When capturing the first image of the area, a direction of entry into the area where the vehicle will be parked may be determined. Then, the first image may be captured with a camera facing the area in front of the vehicle if the direction of entry is a forward direction into the area or with a camera facing the area behind the vehicle if the direction of entry is a reverse entry into the area.

Next, a second image of the parking area is captured while parking exiting from the parking area in operation S215. When capturing the second image of the area, a direction of exit from the area where the vehicle will be parked may be determined. Then, the second image of the area may be captured with a camera facing the area in front of the vehicle if the direction of exit is a reverse exit from the area or with a camera facing the area behind the vehicle if the direction of exit is a forward exit from the area.

The first and second image are analyzed and/or compared in operation S220 to determine whether a fluid leak from a vehicle has occurred. If no fluid leak has occurred or is present (operation S220-No), then the process resets. If a fluid leak has occurred or is present (operation S220-Yes), then the process proceeds to operation S230 to output a notification of the fluid leak.

Optionally, before proceeding to operation S230, the process may perform options S225-S227 to validate the detection of the leak after operation S220-Yes. In operation S225, it may be determined whether the leak is a recurring leak based on historical information. The historical information may be historical images, historical leak detection information, or historical vehicle sensor information. If the detected leak is determined to be a recurring leak (operation S225-Yes), then the process proceeds to operation S226. Otherwise (operation S225-No), the process resets.

In operation S226, the leak detection counter is incremented and then in operation S227 is determined whether the leak detection counter has counted a predetermined threshold number of leaks. If the leak detection counter is above a predetermined threshold number of leaks (operation S227-Yes), then the process proceeds to operation S230 where the notification of the leak is output. Otherwise if the leak detection counter has not reached the predetermined threshold number of detected leaks, the process reset.

FIG. 3 shows a flowchart for a method for determining whether leak detection is active according to an aspect of an exemplary embodiment. The method of FIG. 3 may be performed by the apparatus detects a leak of a vehicle fluid 100 or may be encoded into a computer readable medium as instructions that are executable by a computer to perform the method.

Referring to FIG. 3, rain, snow or other environmental moisture is scanned for in operation S310. If rain, snow or other environmental moisture is detected (operation S310-Yes), then the leak detection is not activated and remains inactive and the process ends. If rain, snow or other environmental moisture is not detected (operation S310-No), the process proceeds operation S320 where a vehicle speed is detected. If the vehicle speed is greater than a predetermined threshold speed (operation S320-No), then the leak detection is not activated and remains inactive and the process ends. If the vehicle speed is less than a predetermined threshold speed (operation S320-Yes), the leak detection is activated in operation S330.

FIG. 4 shows a flowchart for a method for detecting whether a leak is present according to an aspect of an exemplary embodiment. The method of FIG. 4 may be performed by the apparatus detects a leak of a vehicle fluid 100 or may be encoded into a computer readable medium as instructions that are executable by a computer to perform the method.

Referring to FIG. 4, pixels of the first image are compared to pixels of the second image in operation S410. In particular, the colors of pixels are compared to detect a change in color at a corresponding area from the first and second image. In addition, the shape and size of the area with change in color may be determined as well as the location of the pixels that have changed in color. This information on the shape, size and location may be used to determine whether leak has occurred and the type of leak. If no leak is detected in the comparing of the first and second image (Operation S410-No), the process returns no leak. Other is the process detects a leak, whether leak has occurred and the type of leak are returned (Operation S410-Yes).

Optionally, after a leak is detected in (Operation S410-Yes, operations S411-S415 may be performed to validate the leak information. In particular, the location of the leak with respect to the vehicle may be determined in operation S411 and it may be determined whether the location corresponds to a location in the vehicle where a leak may occur in operation 412. The size of the leak may also be determined and compared to sizes of different leak types in operation S413. In operation, the type of leak may be determined based on size of leak, location of leak, or color of pixels. In addition, the condition of the leaked fluid may be determined based on color analysis of the leaked fluid.

In operation S415, the determined leak type and leak information may be cross referenced with information from other sensors to determine a confidence score by comparing the detected leak type and leak information with information from other sensors, vehicle systems, vision systems, historical leak information, and vehicle operator input. The confidence score, leak type, and leak information may then be returned to be output.

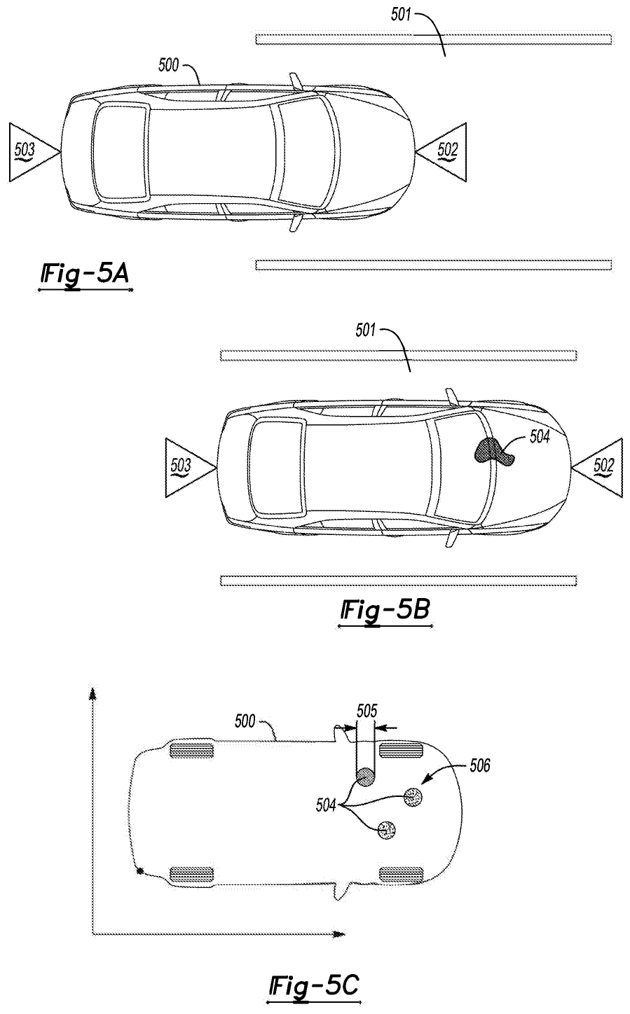

FIGS. 5A-5C show illustrations of the leak detection process according to an aspect of an exemplary embodiment.

Referring to FIG. 5A, a vehicle 500 moving forward into parking area 501 may take a first picture of parking area 501 using a camera 502 with a front field of view. As shown in FIG. 5A, there is no leak in the parking area 501.

Referring to FIG. 5B, a vehicle 500 exiting form parking area 501 may take a second picture of parking area 501 using a camera 502 with a front field of view or using a camera 503 with a rear field of view depending on the direction of the exit. The image may capture fluid spot 504, which was not present in the area 501 prior to the vehicle parking in the area as evidenced by the first image taken in FIG. 5A.

Referring to FIG. 5C, a size 505 and location 506 of various fluid leaks 504 may be determined by analyzing the image and comparing a location of the leaks 504 relative to a location of the camera. By using the known variables and/or the configuration of the camera including focal length of the lens, resolution, the relative location of the camera to the leak 504, the location of the vehicle 500 and the fluid leak 504 relative to parking area 501, the location of the camera on the vehicle 500 and the location of the leaks 504 in the image, the location of the leaks 504 relative to the vehicle 500 can be determined and this information may be used to determine the potential source of the leak and to validate whether a leak exists.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for detecting a leak of vehicle fluid, the method comprising:
determining whether leak detection is active;
capturing a first image of an area while parking a vehicle into the area if the leak detection is active;
capturing a second image of the area while the vehicle is exiting from the area;
comparing the first image and the second image to detect whether the leak is present; and
outputting a notification indicating a leak is present if the comparing detects the leak.

2. The method of claim 1, further comprising:
determining whether the detected leak is a recurring leak based on historical leak information; and
incrementing a leak detection counter if the detected leak is determined to be a recurring leak,
wherein the outputting the notification comprises outputting the notification if the leak detection counter is above a predetermined threshold number.

3. The method of claim 1, wherein the determining whether leak detection is active comprises:
determining whether rain, snow or other environmental moisture is possible based on at least one from among a rain sensor, weather information, and images provided a camera;
determining whether a speed of the vehicle is less than a predetermined threshold speed; and
activating the leak detection if the environmental moisture is not possible and the vehicle speed is less than the predetermined threshold speed.

4. The method of claim 1, wherein the capturing the second image of the area upon exiting the vehicle from the area comprises capturing an image after the vehicle shifts from a stationary vehicle setting to a setting that corresponds to vehicle motion and the vehicle begins moving from the area.

5. The method of claim 1, further comprising detecting a direction of entry into the area where the vehicle will be parked,
wherein capturing the first image comprises capturing the first image of the area with a camera facing the area in front of the vehicle if the direction of entry is a forward direction into the area, and
wherein capturing the first image comprises capturing the first image of the area with a camera facing the area behind the vehicle if the direction of entry is a reverse entry into the area.

6. The method of claim 5, further comprising detecting a direction of exit from the area where the vehicle was parked,
wherein capturing the second image comprises capturing the second image of the area with a camera facing the area in front of the vehicle if the direction of exit is a reverse exit from the area, and
wherein capturing the second image comprises capturing the second image of the area with a camera facing the area behind the vehicle if the direction of exit is a forward exit from the area.

7. The method of claim 1, wherein the comparing the first image and the second image to detect whether the leak is present comprises comparing colors of pixels of the first image to colors of pixels of the second image.

8. The method of claim 7, wherein the comparing the first image and the second image to detect whether the leak is present further comprises determining a location of the leak based on the comparing of the colors, determining if the location of the leak corresponds to a location on the vehicle where a leak may occur, determining a size of the leak, and determining a type of the leak based on one or more from among the size of the leak, the location of the leak, and the color of the pixels.

9. The method of claim 8, wherein the comparing the first image and the second image to detect whether the leak is present further comprises cross-referencing the determined leak type with information from one or more from among other sensors, vehicle systems, vision systems or a vehicle operator and updating the determined leak type based on the cross-referencing.

10. A non-transitory computer readable medium comprising computer executable instructions executable by a processor to perform the method of claim 1.

11. An apparatus that detects a leak of vehicle fluid, the apparatus comprising:
at least one memory comprising computer executable instructions; and
at least one processor configured to read and execute the computer executable instructions, the computer executable instructions causing the at least one processor to:
determine whether leak detection is active;
capture a first image of an area while parking a vehicle into the area if the leak detection is active;
capture a second image of the area while the vehicle is exiting from the area;
compare the first image and the second image to detect whether the leak is present; and
control to output a notification indicating a leak is present if the comparing detects the leak.

12. The apparatus of claim 11, wherein the computer executable instructions further causing the at least one processor to determine whether the detected leak is a recurring leak based on historical leak information, increment a leak detection counter if the detected leak is determined to be a recurring leak, and output the notification by outputting the notification if the leak detection counter is above a predetermined threshold number.

13. The apparatus of claim 11, wherein the computer executable instructions further cause the at least one processor to determine whether leak detection is active by:
determining whether rain, snow or other environmental moisture is possible based on at least one from among a rain sensor, weather information, and images provided a camera;
determining whether a speed of the vehicle is less than a predetermined threshold speed; and
activating the leak detection if the environmental moisture is not possible and the speed of the vehicle is less than the predetermined threshold speed.

14. The apparatus of claim 11, wherein the computer executable instructions further cause the at least one processor to capture the second image of the area upon exiting the vehicle from the area by capturing an image after the vehicle shifts from a stationary vehicle setting to a setting that corresponds to vehicle motion and the vehicle begins moving from the area.

15. The apparatus of claim 11, wherein the computer executable instructions further cause the at least one processor to detect a direction of entry into the area where the vehicle will be parked, capture the first image by capturing the first image of the area with a camera facing the area in front of the vehicle if the direction of entry is a forward direction into the area, and capture the first image by capturing the first image of the area with a camera facing the area behind the vehicle if the direction of entry is a reverse entry into the area.

16. The apparatus of claim 15, wherein the computer executable instructions further cause the at least one processor to detect a direction of exit from the area where the vehicle was parked, capture the second image by capturing the second image of the area with a camera facing the area in front of the vehicle if the direction of exit is a reverse exit from the area, and capture the second image by capturing the second image of the area with a camera facing the area behind the vehicle if the direction of exit is a forward exit from the area.

17. The apparatus of claim 11, wherein the computer executable instructions further cause the at least one processor to compare the first image and the second image to detect whether the leak is present by comparing colors of pixels of the first image to colors of pixels of the second image.

18. The apparatus of claim 17, wherein the computer executable instructions further cause the at least one processor to compare the first image and the second image to detect whether the leak is present by determining a location of the leak based on the comparing of the colors, determining if the location of the leak corresponds to a location on the vehicle where a leak may occur, determining a size of the leak, and determining a type of the leak based on one or more from among the size of the leak, the location of the leak, and the color of the pixels.

19. The apparatus of claim 18, wherein the computer executable instructions further cause the at least one processor to compare the first image and the second image to detect whether the leak is present by cross-referencing the determined leak type with information from one or more from among other sensors, vehicle systems, vehicle maintenance history, vision systems or a vehicle operator and updating the determined leak type based on the cross-referencing.

20. The apparatus of claim 11, wherein the computer executable instructions further cause the at least one processor to assign a confidence score to the determined type of leak based on the information from one or more from among other sensors, vehicle systems, vision systems or a vehicle operator and updating the determined leak type based on the cross-referencing.
